(19) United States
(12) Patent Application Publication
(10) Pub. No.: US 2005/0284892 A1
(43) Pub. Date: Dec. 29, 2005

(54) Grease gun with overpressure relief valve and indicator

(75) Inventors: R. Mark Weems, Cedar Rapids, IA (US); Don R. Linkletter, Cedar Rapids, IA (US)

Correspondence Address: ALLAN L HARMS, 2750 FIRST AVENUE NE, SUITE 420, CEDAR RAPIDS, IA, 52402, US

(73) Assignee: Weems Industries, Inc., d/b/a Legacy Manufacturing Company, Marion, IA (US)

(21) Appl. No.: 11/159,502

(22) Filed: Jun. 23, 2005

Related U.S. Application Data
(60) Provisional application No. 60/582,686, filed on Jun. 24, 2004.

(51) Int. Cl. B65D 88/54; G01F 11/06; G01F 11/30; G01F 11/36; G01F 11/42

(52) U.S. Cl. 222/333

(57) ABSTRACT

A battery powered grease gun has an overpressure relief valve for returning grease to the grease barrel mounted to the grease gun head when a plugged zerk prevents grease from exiting the output port. The grease gun head includes a small relief passageway joined to the output port of the grease gun head which is closed by an adjustable check valve. When the pressure of grease in the output port rises above a preselected pressure, grease will pass through the relief passageway to the grease barrel or, if so equipped, to the grease supply adapter which is mounted to the grease gun head. The grease gun head is additionally provided with a sampling duct which is joined to the output port. The sampling duct couples the output port to another port in which a pressure gauge or a pressure transducer may be installed. The pressure of grease in the output port may be displayed on the pressure gauge or on a display coupled to the transducer.

### CROSS REFERENCE TO RELATED APPLICATION

This application claims the benefit of pending provisional U.S. patent application Ser. No. 60/582,686 filed Jun. 24, 2004 entitled “Battery Powered Grease Gun,” the contents of which are incorporated in full herein.

### BACKGROUND OF THE INVENTION

This invention pertains to powered grease guns and particularly to portable battery powered grease guns.

Existing portable battery powered grease guns operate by the repeated compression of a motor-driven compression mechanism such as a reciprocating plunger moving through a compression chamber. Grease compressed by the plunger moving through the compression chamber will move through an exit check valve which is biased by a spring to prevent grease from exiting the compression chamber at a pressure less than a preselected preferred pressure. Grease exiting the compression chamber at sufficient pressure overcomes the exit check valve and passes through an outlet port either directly from the grease gun into a grease zerk on a machine to be lubricated, or from the outlet port of the grease gun into a hose which terminates in a zerk coupler. When no restriction in movement of grease through the outlet port is encountered, the grease gun operation is satisfactory. However, if a clogged or otherwise stubborn grease zerk is encountered, the operation of the grease gun can create an overpressure condition within the grease gun head causing leaks and damage to seal components of the grease gun, wear on the grease gun compression mechanism, or possible explosion of the grease gun.

Prior efforts to overcome the problems with overpressure within the grease gun head when back pressure in the outlet port is encountered due to a clogged grease zerk have included a battery powered grease gun with relief check valve which allow grease to be exhausted into the environment directly from the grease gun head. This apparatus permits grease to be spilled and to coat the exterior of the grease gun. A solution to permit return of grease under excess pressure into the grease supply is needed when an overpressure condition is encountered.

### BRIEF SUMMARY OF THE INVENTION

A battery or powered grease gun is disclosed which is provided with a passageway through which grease at elevated pressure may be returned to the source of grease coupled to the grease gun. The grease gun head includes a small relief passageway joined to the compression chamber of the grease gun head which is closed by an adjustable check valve biased by a spring. When grease at a pressure above a preselected pressure is present in the relief passageway, the bias of the check valve is overcome and grease may pass from the relief passageway to a return conduit which is joined to the grease barrel or the grease supply hose adapter which is mounted to the grease gun head. Grease at excess pressure within the compression chamber may therefore be vented back to the grease barrel or into the adapter which supplies grease to the grease gun head.

The grease gun head is additionally provided with a sampling duct which is joined to the compression chamber. The sampling duct couples the compression chamber to a port in which a pressure gauge may be installed. Alternatively a pressure transducer may be installed in the port. The pressure transducer is electrically coupled to an external display on which the pressure of grease in the sampling duct may be indicated visually. If a pressure gauge is installed in the port in place of a pressure transducer, the pressure of grease in the compression chamber and the sampling duct may be displayed on the pressure gauge.

It is accordingly a first object of the invention to provide an improved grease gun head for a battery powered grease gun which vents grease above a preselected pressure back to the grease source.

It is an additional object of the invention to provide a grease gun head with a relief valve which may be adjusted by the user.

It is a second object of the invention to provide a grease gun which includes a display indicating the internal grease pressure within the grease gun head.

It is a further object of the invention to provide a grease gun with an easily understood indicator which signals the presence of elevated pressure of grease within the grease gun head.

These and other objects of the invention will be apparent from examination of the drawings and the detailed description of the invention which follows.

### BRIEF DESCRIPTION OF THE SEVERAL VIEWS OF THE DRAWING(S)

FIG. 1 is a front elevation of an exemplary battery operated grease gun.

FIG. 2 is a front elevation of a grease gun head, with cover removed, of a battery powered grease gun according to the present invention.

FIG. 3 is a section taken along line 3-3 of FIG. 2.

FIG. 4 is a section taken along line 4-4 of FIG. 2.

FIG. 5 is a transverse cross section of an alternative grease gun head equipped with an optional pressure transducer and display.

FIG. 6 is an enlarged front elevation of an exemplary display for a grease gun equipped with a pressure transducer.

FIG. 7 discloses the battery powered grease gun of FIG. 1 coupled to a remote pressurized grease supply.

### DETAILED DESCRIPTION OF THE INVENTION

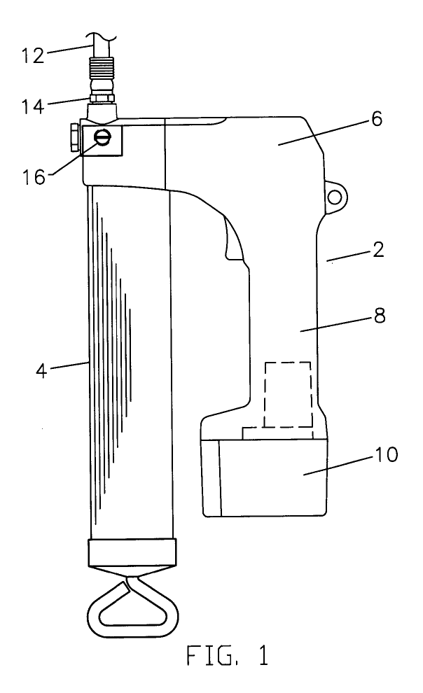

Referring to FIG. 1, an exemplary portable grease gun 2 is illustrated which includes a barrel 4 containing a supply of grease and a grease gun head 6 joined to a handle 8. A battery 10 is coupled electronically and mechanically to handle 8. The grease gun head 6 is coupled to a grease conduit 12 such as a flexible hose by fittings 14. An adjusting screw 16 is provided on the grease gun head 6 to permit a user to adjust the pressure of grease within the head at which grease will be bled off to the barrel 4. This adjusting screw may additionally be fitted with an external pointer (not shown) to allow the user to set a desired pressure when aligned with a calibrated dial on the head. The adjusting screw may alternatively be adjustable with the use of a tool such as an allen wrench or a screwdriver, or it may be provided with a knob which can be restricted manually. The grease barrel 4 may be removed and an adapter for attachment of a hose attached in the place of barrel 4. The adapter with attached hose would permit transfer of grease from a grease canister or other bulk supply to the grease gun head 6.

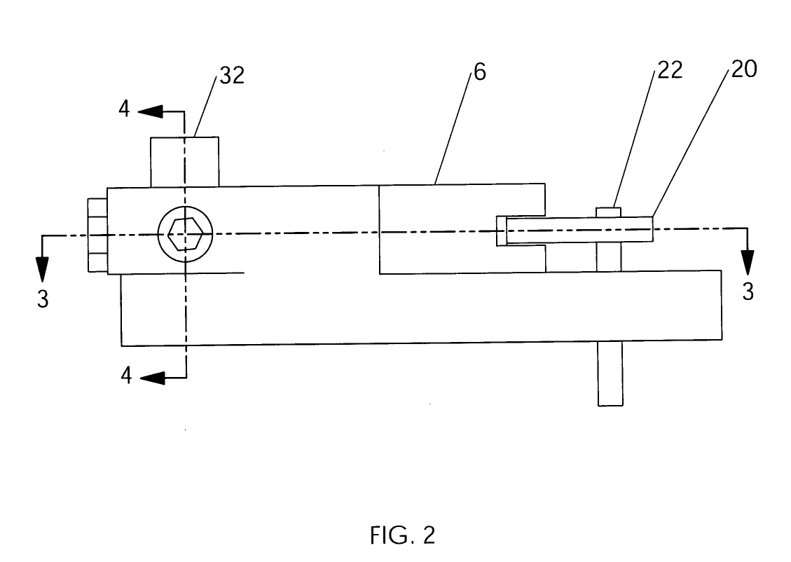

Referring now to FIGS. 2-4, the internal mechanics within grease gun head 6 are schematically illustrated. An eccentrically mounted cam disk 20 is driven in rotation by a drive shaft 22 which is rotated by a battery powered motor which is not shown in this figure but which is housed within handle 8 of grease gun 2 as seen in FIG. 1. As cam disk 20 rotates, plunger 24 reciprocates along passageway 26. Grease entering passageway 26 from inlet port 18 is forced along passageway 26 by plunger 24 until it enters compression chamber 28 wherein the pressure of grease therein is raised by the thrusting movement of plunger 24. Once at sufficient pressure to overcome the bias of outlet check valve 30, grease passes into grease exit port 32 and may exit port 32 into a hose or other conduit such as grease conduit 12 seen in FIG. 1. Plunger 24 is urged away from compression chamber 28 by main return spring 34 which is disposed in enlarged bore 35.

An elongate axial bore 46 extends partway through plunger 24 from the head 48 thereof such that cross bore 62 of plunger 24 intercepts axial bore 46 and will communicate with inlet 18 so that grease at inlet 18 may move along and within plunger 24 to provide lubrication of cam disk 20 as it engages head 48 of plunger 24.

Grease enters passageway 26 from inlet port 18 which is communicative with the interior of grease barrel 4, which contains a source of grease under slightly elevated pressure. As plunger 24 is urged toward check valve 30 by cam disk 20, grease is forced from inlet port 18 into compression chamber 28 and urges check valve 30 to be displaced, allowing grease at sufficient working pressure to flow past check valve 30 and into exit port 32. A cap screw 36 holds check valve spring 38 in place to urge ball 40 against seat 37.

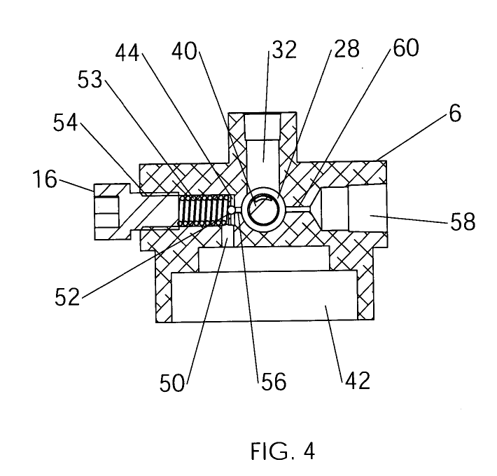

Typically, exit port 32 will be coupled to a conduit 12 (see FIG. 1) to assist in delivery of grease distant from the grease gun. Should grease not flow freely through exit port 32, due, for example, to resistance of a plugged zerk to accept grease, the reciprocating action of plunger 24 will cause pressure of grease in the compression chamber 28 and in exit port 32 to rise above the working pressure. Once the grease pressure in compression chamber 28 reaches a predetermined level, grease may be vented from exit port 32 back into the barrel 4 through a relief passageway 50 best seen in FIG. 4.

It may be observed in FIG. 4 that head 6 includes barrel receiver 42 which is a connection point for a grease barrel 4. Barrel receiver 42 is typically internally threaded so that the open end of barrel 4 may be threaded into barrel receiver 42. The relief passageway 50 is communicative with barrel receiver 42 and with a collection chamber 44 containing relief check valve 52. Relief passageway 50 is of substantially smaller cross section than exit port 32. Adjusting screw 16 is received in threaded bore 54 and may be adjusted to vary the force needed to overcome relief check valve 52. When pressure of grease in exit port 32 exceeds a predetermined level controlled by the adjustment of adjusting screw 16, relief check valve 52 is deflected from its seat and grease may leave exit port 32 and pass along relief conduit 56 past relief check valve 52 and into relief passageway 50 which allows the grease to return to the supply within barrel 4. The bias provided by relief check spring 53 is greater than that of check valve spring 38 so that grease will not pass relief check valve 52 unless check valve 30 is open.

A pressure gauge (not illustrated) may be installed in gauge port 58 to measure the pressure of grease in exit port 32. A small sampling duct 60 interconnects exit port 32 and gauge port 58. Sampling duct 60, like relief conduit 56, is much smaller in cross section than exit port 32. Grease under pressure may pass along sampling duct 60 to be urged against a diaphragm of a pressure gauge which may be installed in gauge port 58. As an alternative to a gauge mounted in gauge port 58, a hose may be coupled to gauge port 58 to convey the grease pressure in sampling duct 60 to a remote measuring device.

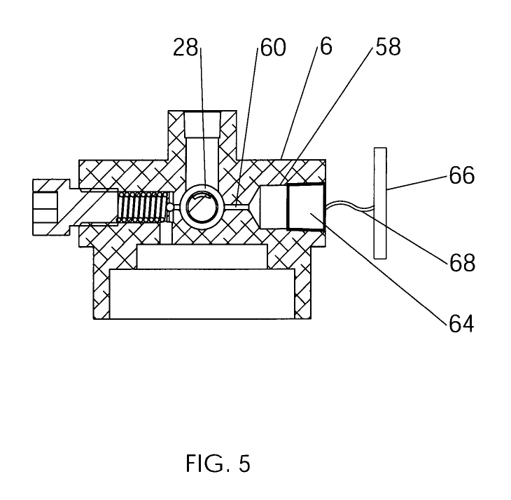

In FIG. 5, an alternative embodiment of the grease gun head 6 is illustrated. In this alternate embodiment, grease gun head 6 is provided with a pressure transducer 64 fitted into gauge port 58 and communicative with sampling duct 60 such that pressure of grease in exit port 32 is sampled and may be detected by pressure transducer 64. Signals from pressure transducer 64 may be transmitted along wiring 68 to display 66 at which the sensed pressure in exit port 32 may be visually displayed exterior to the grease gun head 6.

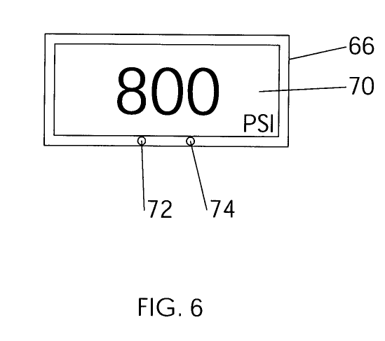

FIG. 6 discloses an exemplary display 66 which includes an LCD array 70 or similar display panel on which the pressure within grease gun head 6 may be displayed.

Display 66 may include a controller to convert the raw pressure data from the pressure transducer 64 of FIG. 5 into a numeric output on LCD array 70. Warning lamps 72, 74 may be provided on display 66 to alert the user of an overpressure condition or other malfunction of the grease gun, signals for which would be generated by a preset entry in the controller of display 66. The LEDs may be used in place of the LCD array 70 in an alternate configuration. An intermediate controller for LCD array 70 is not illustrated but is well known in the display controller art.

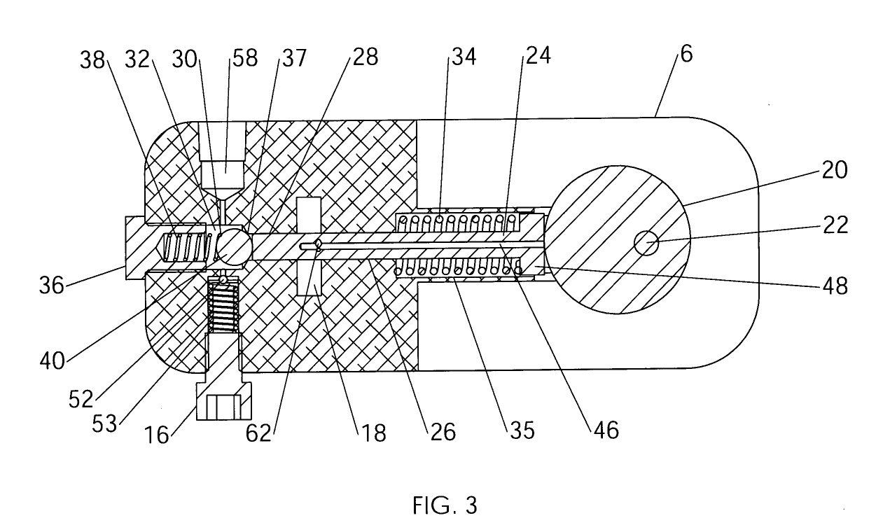

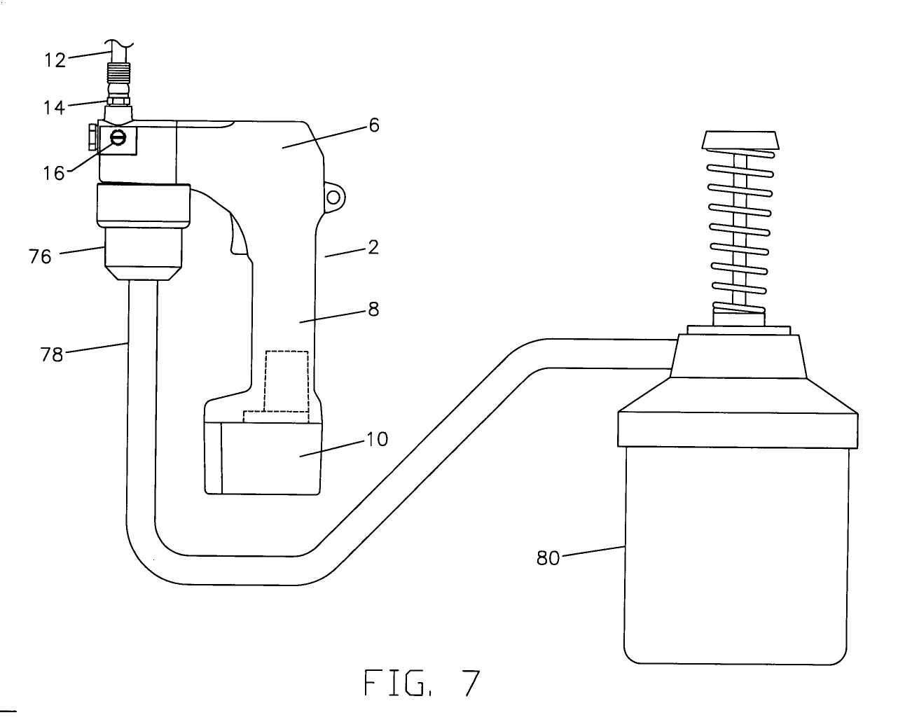

FIG. 7 discloses an embodiment of the battery powered grease gun head 6 coupled to an adapter 76 coupled to a hose 78 coupled to a pressurized grease supply reservoir 80. Grease within supply reservoir 80 may pass under slightly elevated pressure along hose 78 to adapter 76 which is received in barrel receiver 42 in place of a grease barrel. If grease is prevented from exiting grease conduit 12, the internal pressure of grease in grease gun head 6 will rise as the motor driving the plunger 24 operates. Grease within the exit port 32 (see FIG. 3), when pressure thereof substantially exceeds working pressure, may be vented into adapter 76 through relief passageway 50 (see FIG. 3). The pressure at which grease is vented to adapter 76 is selected by adjustment of adjusting screw 16.

The foregoing description of the invention has been presented for purposes of illustration and description and is not intended to be exhaustive or to limit the invention to the precise form disclosed. Modifications and variations of the embodiments are possible in light of the above disclosure or such may be acquired through practice of the invention. The embodiments illustrated were chosen in order to explain the principles of the invention and its practical application to enable one skilled in the art to utilize the invention in various embodiments and with various modifications as are suited to the particular use contemplated. It is intended that the scope of the invention be defined by the claims appended hereto, and by their equivalents.

1. A portable battery operated grease gun comprising
a grease gun head selectively coupled to a supply of grease at a connection point,
a plunger reciprocal within a passageway in the grease gun head,
the passageway communicative with a compression chamber,
the plunger operable to compress grease within the compression chamber of the passageway,
the passageway communicative with an inlet port communicative with the connection point,
an exit check valve disposed between an exit port and the compression chamber,
a relief passage communicative with the exit port and with the connection point,
a relief check valve preventing grease below a selected pressure from passing along the relief passage to the connection point.

2. The portable battery operated grease gun of claim 1 wherein
a pressure gauge is mounted to the grease gun head at a gauge port thereon,
the gauge port coupled to a sampling duct communicative with the exit port,
whereby pressure within the exit port may be measured by the pressure gauge.

3. The portable battery operated grease gun of claim 1 wherein
the relief check valve is a ball biased by a valve spring against a seat,
the valve spring compressed by an adjustment screw,
the adjustment screw selectively adjustable by a user of the grease gun,
whereby the selected pressure below which passage of grease is blocked by the relief check valve may be adjusted.

4. The portable battery operated grease gun of claim 1 wherein
the supply of grease is a grease barrel selectively mounted to the connection point,
the grease barrel having an open end communicative with the connection point,
whereby grease passing the relief check valve passes into the grease barrel.

5. The portable battery operated grease gun of claim 3 wherein,
the adjusting screw may comprise a knob having a pointer.

6. The portable battery operated grease gun of claim 1 wherein
the connection point is capable of receiving a grease containing barrel,
an adapter selectively mounted to the connection point,
the adapter coupled to a bulk supply of grease,
the adapter having an open end communicative with the connection point,
whereby grease passing the relief check valve passes into the adapter.

7. The portable battery operated grease gun of claim 1 wherein
the plunger includes a longitudinal bore extending from a head thereof along a substantial portion of the length of the plunger,
the plunger having a cross bore intercepting the longitudinal bore thereof,
the cross bore communicative with the connection point,
the plunger driven by a cam interactive with the head thereof,
whereby grease may enter the longitudinal bore and pass therealong to the head of the plunger to lubricate the cam.

8. A portable grease gun comprising
a grease gun head coupled to a supply of grease,
compression means for compressing grease within a compression chamber in the grease gun head,
the compression chamber communicative with an inlet port communicative with the supply of grease,
the grease gun head further comprising an exit check valve disposed between an exit port and the compression chamber,
the exit check valve permitting grease at or above a working pressure to pass thereby into the exit port,
the grease gun head comprising a relief passage communicative with the exit port and with the supply of grease,
a relief check valve disposed along the relief passage permitting grease above a pressure in excess of the working pressure to pass along the relief passage to the supply of grease.

9. The portable grease gun of claim 8 wherein
the relief check valve is selectively adjustable for the pressure at which the relief check valve permits grease to pass thereby.

10. The portable grease gun of claim 8 wherein
the relief check valve is adjustable by adjustment of an adjusting screw carried on the grease gun head.

11. The portable grease gun of claim 8 wherein
the grease gun head includes a pressure gauge port,
the pressure gauge port coupled to the exit port by a small cross section sampling duct,
pressure indication means is installed in the pressure gauge port.

12. A portable grease gun comprising
a grease gun head having a exit port therein,
the grease gun head including a pressure gauge port,
the pressure gauge port coupled to the exit port by a small cross section sampling duct,
whereby pressure of grease within the exit port may be indicated to a user by a pressure monitor mounted within the pressure gauge port.

13. The portable grease gun of claim 12 wherein
the pressure monitor is a pressure gauge mounted within the pressure gauge port.

14. The portable grease gun of claim 12 wherein
the pressure monitor is a pressure transducer mounted within the pressure gauge port,
the pressure transducer coupled to an indicator external to the grease gun head.

15. The portable grease gun of claim 14 wherein
the indicator comprises a visual display mounted to the grease gun head.

16. The portable grease gun of claim 15 wherein
the visual display comprises an LED array.

17. The portable grease gun of claim 15 wherein
the visual display comprises at least one warning indicator.

18. The portable battery operated grease gun of claim 1 wherein
the relief check valve is a ball biased by a valve spring against a seat,
the valve spring compressed by an adjustment screw,
the adjustment screw selectively adjustable by a user of the grease gun to vary the bias of the valve spring,
when seated against the seat, the ball preventing grease from passing along the relief passage,
the relief passage substantially smaller in cross section than the exit port of the grease gun head,
the supply of grease is contained in a grease barrel selectively mounted to the connection point,
the grease barrel having an open end communicative with the connection point,
whereby grease passing the relief check valve passes into the grease barrel.

19. The portable battery operated grease gun of claim 1 wherein
the grease gun head includes a pressure gauge port,
the pressure gauge port coupled to the exit port by a small cross section sampling duct,
pressure indication means installed in the pressure gauge port.

20. The portable battery operated grease gun of claim 19 wherein
the pressure indication means is a pressure transducer,
the pressure transducer coupled to a display,
the display indicating the pressure of grease within the exit port.
